(19) United States
(12) Patent Application Publication
(10) Pub. No.: US 2025/0174044 A1
(43) Pub. Date: May 29, 2025

(54) APPARATUS AND METHOD FOR BIOMETRIC AUTHENTICATION BASED ON EYE IMAGE

(71) Applicant: ELECTRONICS AND TELECOMMUNICATIONS RESEARCH INSTITUTE, Daejeon (KR)

(72) Inventors: Jong-Hyouk NOH, Daejeon (KR); Young-Sam KIM, Daejeon (KR); Soo-Hyung KIM, Sejong-si (KR); Seok-Hyun KIM, Daejeon (KR); Kwan-Tae CHO, Daejeon (KR); Sang-Rae CHO, Okcheon-gun (KR); Young-Seob CHO, Daejeon (KR); Jin-Man CHO, Daejeon (KR); Seung-Hun JIN, Daejeon (KR)

(73) Assignee: ELECTRONICS AND TELECOMMUNICATIONS RESARCH INSTITUTE, Daejeon (KR)

(21) Appl. No.: 18/663,445

(22) Filed: May 14, 2024

(30) Foreign Application Priority Data
Nov. 28, 2023 (KR) 10-2023-0167650

(51) Int. Cl. G06V 40/18; G06V 10/24; G06V 10/26

(52) U.S. Cl. CPC G06V 40/197; G06V 10/24; G06V 10/267; G06V 40/193

(57) ABSTRACT

Disclosed herein is an apparatus and method for biometric authentication based on an eye image The apparatus receives the eye image to be authenticated that captures a region around an eye of a subject, generates segmentation data and eye state information from the eye image to be authenticated, selects a registered eye image based on similarity acquired by comparing the segmentation data and eye state information of the eye image to be authenticated with those of previously registered eye images, and authenticates the subject based on the similarity.

### CROSS REFERENCE TO RELATED APPLICATION

This application claims the benefit of Korean Patent Application No. 10-2023-0167650, filed Nov. 28, 2023, which is hereby incorporated by reference in its entirety into this application.

### BACKGROUND OF THE INVENTION

### 1. Technical Field

The present disclosure relates generally to biometric authentication technology, and more particularly to biometric authentication technology based on an eye image capturing a region around an eye.

### 2. Description of the Related Art

Periocular recognition technology, which is one of biometric authentication technologies, is technology capable of authenticating and identifying individuals using biometric information of a region around eyes. Iris recognition technology uses iris patterns to identify users, whereas periocular recognition uses a region around eyes, including eyelids, eyelashes, skin around the eyes, and the like, for recognition.

Periocular recognition technology is effective for recognizing individuals wearing masks. Also, periocular recognition is used for authentication of users wearing a Head-Mounted Display (HMD), which is a Virtual Reality (VR) device.

A biometric authentication method using images, such as iris authentication, periocular authentication, facial authentication, palmprint authentication, or the like, is divided into two stages, which are a registration process and an authentication process. In the registration process, the biometric information of a user is acquired and stored in secure storage. In the authentication process, the biometric information of a user is acquired and compared with the biometric information stored in the registration process in order to check whether the user is a registered user, whereby whether the biometric information of the user is the biometric information of the same user is determined.

Because biometric information may include a lot of noise due to the condition of a user and a surrounding environment, multiple piece of information are stored in the registration process in order to improve authentication performance. In the case of a face, facial features may vary each time due to the angle of the face, surrounding lighting conditions, and the like. Therefore, facial images captured from different angles are stored in the registration process. In periocular authentication, similar to the facial authentication, different features are exhibited depending on a camera angle, eyelid movement, and a gaze direction, thus multiple eye region images are captured and stored in the registration process.

When a user wearing an HMD device is authenticated, it is not easy to obtain an input image suitable for authentication, because the user looks in various directions while focusing his or her gaze on the display of the HMD device. Particularly when implicit authentication that does not require user cooperation is attempted, authentication becomes more challenging.

### SUMMARY OF THE INVENTION

An object of the present disclosure is to perform biometric authentication by selecting an image most similar in shape to the eye image to be authenticated from among registered images.

Another object of the present disclosure is to select a registered eye image similar to the eye image to be authenticated, thereby improving authentication performance.

In order to accomplish the above objects, an apparatus for biometric authentication based on an eye image according to an embodiment of the present disclosure includes one or more processors and memory for storing at least one program executed by the one or more processors. The at least one program receives an eye image to be authenticated that captures a region around an eye of a subject, generates segmentation data and eye state information from the eye image to be authenticated, selects a registered eye image based on similarity acquired by comparing the segmentation data and eye state information of the eye image to be authenticated with those of previously registered eye images, and authenticates the subject based on the similarity.

Here, the segmentation data may be configured such that the eye image capturing the region around the eye is divided into regions of a pupil, an iris, a sclera, and a background.

Here, the at least one program may correct the tilt of the eye such that the left and right ends of the sclera are horizontally aligned in the segmentation data, and may correct the center of the image such that the center of the pupil becomes the center of the eye image.

Here, the at least one program may generate the eye state information about the top, bottom, left, and right positions of the pupil and an eye size from the segmentation data.

Here, the at least one program may calculate an eye difference score using the sum of a difference in the top, bottom, left, and right positions of the pupil between the eye image to be authenticated and the registered eye image, a difference in the eye size therebetween, and mean Intersection over Union (mIoU) therebetween.

Here, the at least one program may calculate the eye difference score by setting respective weights for the difference in the top, bottom, left, and right positions of the pupil, the difference in the eye size, and the mIoU.

Here, the at least one program may extract feature vectors from the eye image to be authenticated and the selected registered eye image.

Here, the at least one program may authenticate the subject based on a result of comparing the feature vectors of the eye image to be authenticated with those of the selected registered eye image.

Also, in order to accomplish the above objects, a method for biometric authentication based on an eye image, performed by an apparatus for biometric authentication based on an eye image, according to an embodiment of the present disclosure includes receiving an eye image to be authenticated that captures a region around an eye of a subject, generating segmentation data and eye state information from the eye image to be authenticated, selecting a registered eye image based on similarity acquired by comparing the segmentation data and eye state information of the eye image to be authenticated with those of previously registered eye images, and authenticating the subject based on the similarity.

Here, the segmentation data may be configured such that the eye image capturing the region around the eye is divided into regions of a pupil, an iris, a sclera, and a background.

Here, generating the segmentation data and the eye state information may comprise correcting the tilt of the eye such that the left and right ends of the sclera are horizontally aligned in the segmentation data and correcting the center of the image such that the center of the pupil becomes the center of the eye image.

Here, generating the segmentation data and the eye state information may comprise generating the eye state information about the top, bottom, left, and right positions of the pupil and an eye size from the segmentation data.

Here, selecting the registered eye image may comprise calculating an eye difference score using the sum of a difference in the top, bottom, left, and right positions of the pupil between the eye image to be authenticated and the registered eye image, a difference in the eye size therebetween, and mean Intersection over Union (mIoU) therebetween.

Here, selecting the registered eye image may comprise calculating the eye difference score by setting respective weights for the difference in the top, bottom, left, and right positions of the pupil, the difference in the eye size, and the mIoU.

Here, the method for biometric authentication based on an eye image may further include extracting feature vectors from the eye image to be authenticated and the selected registered eye image.

Here, authenticating the subject may comprise authenticating the subject based on a result of comparing the feature vectors of the eye image to be authenticated with those of the selected registered eye image.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for biometric authentication based on an eye image according to an embodiment of the present disclosure;

FIG. 2 is a flowchart illustrating a method for biometric authentication based on an eye image according to an embodiment of the present disclosure;

FIG. 3 is a flowchart illustrating in detail an example of the image-processing step illustrated in FIG. 2;

FIG. 4 is a view illustrating segmentation data of an eye image according to an embodiment of the present disclosure;

FIG. 5 is a view illustrating a process of calculating Intersection over Union (IoU) between the eye image to be authenticated and a registered eye image according to an embodiment of the present disclosure; and

FIG. 6 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

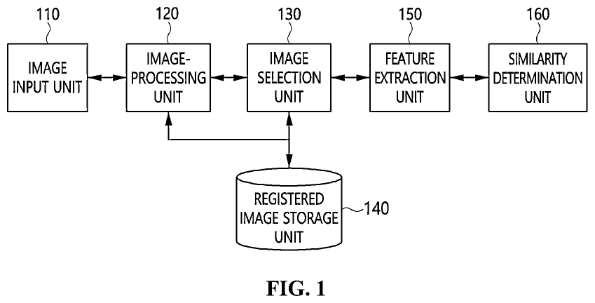

FIG. 1 is a block diagram illustrating an apparatus for biometric authentication based on an eye image according to an embodiment of the present disclosure.

Referring to FIG. 1, the apparatus for biometric authentication based on an eye image according to an embodiment of the present disclosure includes an image input unit 110, an image-processing unit 120, an image selection unit 130, a registered image storage unit 140, a feature extraction unit 150, and a similarity determination unit 160.

The apparatus for biometric authentication based on an eye image according to an embodiment of the present disclosure may perform a registration process.

The image input unit 110 may receive the eye image to be registered that captures a region around an eye of a subject.

Here, the image input unit 110 may induce the subject to gaze in various directions, including front, up, down, left and right directions.

Here, the image input unit 110 may capture eye images for multiple gaze directions in which the gaze of the subject is directed.

Here, the image input unit 110 may capture an eye image for an eye blinking action.

The image-processing unit 120 may generate segmentation data in which the eye image to be registered is divided into regions.

Here, the segmentation data may be configured such that the eye image is divided into pupil, iris, sclera, and background regions.

Here, the image-processing unit 120 may perform correction based on the segmentation data such that the center of the eye (the part including all of the pupil, the iris, and the sclera) becomes the center of the image.

Here, the image-processing unit 120 may correct the tilt of the eye such that the left and right ends of the sclera are horizontally aligned in the segmentation data.

Here, the image-processing unit 120 may correct the center of the image such that the center of the pupil becomes the center of the eye image in the segmentation data.

The center of the pupil may be used when the image is corrected such that the position of the eye becomes the center of the image.

Here, when the eye image includes no pupil, this corresponds to the case in which the eyelid covers a pupil, so the image-processing unit 120 may perform processing such that the coordinates of the uppermost point in the horizontal center of the iris replaces the center of the pupil.

Here, the image-processing unit 120 may crop the eye image from the segmentation data so as to fit specifications for periocular recognition.

Here, the image-processing unit 120 may generate eye state information (the top, bottom, left, and right positions of the pupil and the size of the eye) from the segmentation data.

The eye state information may include the top, bottom, left, and right positions of the pupil and the size of the eye.

Here, the image-processing unit 120 may calculate the top and bottom positions of the pupil using the distances from the center of the pupil to the background in the up and down directions.

Here, the image-processing unit 120 may calculate the left and right positions of the pupil using the distances from the center of the pupil to the left and right ends of the sclera.

Here, the image-processing unit 120 may calculate the size of each of the pupil, the iris, and the sclera as the size of the eye.

Here, the image-processing unit 120 may calculate the size of the eye (the sum of the sizes of the pupil, the iris, and the sclera) in order to acquire the degree of eye opening.

Here, the image-processing unit 120 may perform normalization in order to correct the difference in scale between the top, bottom, left and right positions of the pupil and the eye size data of the eye state information.

Min-Max normalization, Z-score normalization, or the like may be used for a normalization algorithm.

Here, the image-processing unit 120 may store the captured eye images for the multiple gaze directions and the eye image for the eye blinking action in the registered image storage unit 140 as the eye images of the subject.

Here, the image-processing unit 120 may store the segmentation data and the eye state information of the registered eye image in the registered image storage unit 140.

The registered image storage unit 140 may store the eye image capturing the region around the eye of the subject as the registered eye image.

The apparatus for biometric authentication based on an eye image according to an embodiment of the present disclosure may perform an authentication process.

The image input unit 110 may receive the eye image to be authenticated that captures a region around an eye of a subject.

Here, the image input unit 110 may induce the subject to gaze in various directions, including front, up, down, left and right directions.

Here, the image input unit 110 may capture eye images for multiple gaze directions in which the gaze of the subject is directed.

Here, the image input unit 110 may capture an eye image for an eye blinking action.

The image-processing unit 120 may generate segmentation data and eye state information from the eye image to be authenticated.

Here, the image-processing unit 120 may generate segmentation data in which the eye image to be authenticated is divided into regions.

Here, the segmentation data may be configured such that the eye image is divided into pupil, iris, sclera, and background regions.

Here, the image-processing unit 120 may perform correction based on the segmentation data such that the center of the eye (the part including all of the pupil, the iris, and the sclera) becomes the center of the image.

Here, the image-processing unit 120 may correct the tilt of the eye such that the left and right ends of the sclera are horizontally aligned in the segmentation data.

Here, the image-processing unit 120 may correct the center of the image such that the center of the pupil becomes the center of the eye image in the segmentation data.

Here, the image-processing unit 120 may crop the eye image from the segmentation data so as to fit preset specifications for periocular recognition.

Here, the image-processing unit 120 may generate eye state information (the top, bottom, left, and right positions of the pupil and the size of the eye) from the segmentation data.

The eye state information may include the top, bottom, left, and right positions of the pupil and the size of the eye.

Here, the image-processing unit 120 may calculate the top and bottom positions of the pupil using the distances from the center of the pupil to the background in the up and down directions.

Here, the image-processing unit 120 may calculate the left and right positions of the pupil using the distances from the center of the pupil to the left and right ends of the sclera.

Here, the image-processing unit 120 may calculate the size of each of the pupil, the iris, and the sclera as the size of the eye.

Here, the image input unit 110 may calculate the size of the eye (the sum of the sizes of the pupil, the iris, and the sclera) in order to acquire the degree of eye opening.

The center of the pupil may be used when the image is corrected such that the position of the eye becomes the center of the image.

Here, when the eye image includes no pupil, this corresponds to the case in which the eyelid covers the pupil, so the image-processing unit 120 may perform processing such that the coordinates of the uppermost point in the horizontal center of the iris replaces the center of the pupil.

Here, the image-processing unit 120 may perform normalization in order to correct the difference in scale between the top, bottom, left and right positions of the pupil and the eye size data of the eye state information.

Min-Max normalization, Z-score normalization, or the like may be used for a normalization algorithm.

The image selection unit 130 may select a registered eye image based on the similarity acquired by comparing the segmentation data and eye state information of the eye image to be authenticated with those of previously registered eye images.

Here, the image selection unit 130 may acquire the eye state information and segmentation data of the registered eye images from the registered image storage unit 140.

Here, the image selection unit 130 may select a registered eye image most similar to the eye image to be authenticated using the eye state information and segmentation data of the eye image to be authenticated and those of the registered eye images.

Here, the image selection unit 130 may select the most similar registered eye image using the top, bottom, left and right positions of the pupil and the eye size.

Here, the image selection unit 130 may select the most similar registered eye image by calculating mean Intersection over Union (mIoU) between the segmentation data of the eye image to be authenticated and the segmentation data of the registered eye images.

Here, the image selection unit 130 may set respective weights for the difference in the top, bottom, left and right positions of the pupil between the eye image to be authenticated and the registered eye images, the difference in the eye size therebetween, and the mIoU therebetween and calculate an eye difference score (EyeDiffScore) using Equation (1):

$$EyeDiffScore = {w}_{1} \vert {EyePos}_{Input} - {EyePos}_{Registered} \vert + {w}_{2} \vert {EyeSize}_{Input} - {EyeSize}_{Registered} \vert + {w}_{3} ( 1 - mIoU ( {Segmentation}_{Input} , {Segmentation}_{Registered} ) ) \qquad ( 1 )$$

Here, the image selection unit 130 may select the registered eye image having the smallest eye difference score (EyeDiffScore).

Here, the image selection unit 130 may alternatively select multiple registered eye images having an eye difference score equal to or less than a preset eye difference score (EyeDiffScore).

The registered image storage unit 140 may store the registered eye images of subjects.

The feature extraction unit 150 may extract feature vectors from the eye image to be authenticated and the selected registered eye image.

The similarity determination unit 160 may authenticate the subject based on the similarity.

Here, the similarity determination unit 160 may authenticate the subject based on the result of comparing the feature vectors of the eye image to be authenticated with those of the selected registered eye image.

When the eye image to be authenticated and the registered eye image to be compared therewith have different poses, authentication performance may be degraded. For example, when the eye image to be authenticated captures the eye looking up and to the right but the registered image captures a half-closed eye, it is difficult to determine whether the two eye images are the eye images of the same person even though the two images are the images of the same person. Therefore, when a similar looking image is found and compared, authentication performance may be improved.

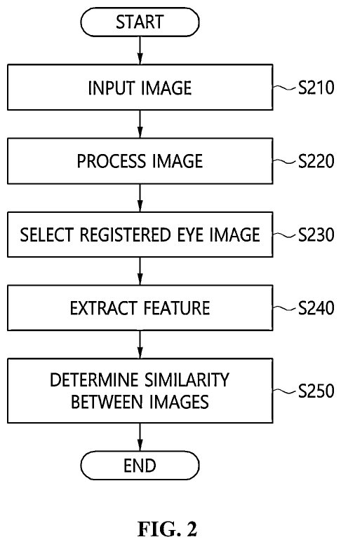

FIG. 2 is a flowchart illustrating a method for biometric authentication based on an eye image according to an embodiment of the present disclosure. FIG. 3 is a flowchart illustrating in detail an example of the image-processing step illustrated in FIG. 2.

Referring to FIG. 2, in the method for biometric authentication based on an eye image according to an embodiment, first, an image may be input at step S210.

That is, the eye image to be authenticated, which captures a region around an eye of a subject, may be input at step S210.

Here, at step S210, the subject may be induced to gaze in various directions including front, up, down, left and right directions.

Here, at step S210, eye images for the multiple gaze directions in which the gaze of the subject is directed may be captured.

Here, at step S210, an eye image for an eye blinking action may be captured.

Also, in the method for biometric authentication based on an eye image according to an embodiment of the present disclosure, the image may be processed at step S220.

That is, segmentation data and eye state information may be generated from the eye image to be authenticated at step S220.

Referring to FIG. 3, at step S220, first, segmentation data may be generated at step S221.

That is, at step S220, segmentation data in which the eye image to be authenticated is divided into regions may be generated.

Here, the segmentation data may be configured such that the eye image is divided into pupil, iris, sclera, and background regions.

Also, at step S220, the segmentation data may be corrected at step S222.

That is, at step S222, correction may be performed based on the segmentation data such that the center of the eye (the part including all of the pupil, the iris, and the sclera) becomes the center of the image.

Here, at step S222, the tilt of the eye may be corrected such that the left and right ends of the sclera are horizontally aligned in the segmentation data.

Here, at step S222, the center of the image may be corrected such that the center of the pupil becomes the center of the eye image in the segmentation data.

The center of the pupil may be used when the image is corrected such that the position of the eye becomes the center of the image.

Here, at step S222, when the eye image includes no pupil, this corresponds to the case in which the eyelid covers the pupil, so processing may be performed such that the coordinates of the uppermost point in the horizontal center of the iris replaces the center of the pupil.

Here, at step S222, the eye image may be cropped from the segmentation data so as to fit preset specifications for periocular recognition.

Also, at step S220, eye state information may be generated at step S223.

That is, at step S223, eye state information (the top, bottom, left, and right positions of the pupil and the size of the eye) may be generated from the segmentation data.

The eye state information may include the top, bottom, left, and right positions of the pupil and the size of the eye.

Here, at step S223, the top and bottom positions of the pupil may be calculated using the distances from the center of the pupil to the background in the up and down directions.

Here, at step S223, the left and right positions of the pupil may be calculated using the distances from the center of the pupil to the left and right ends of the sclera.

Here, at step S223, the size of each of the pupil, the iris, and the sclera may be calculated as the size of the eye.

Here, at step S223, the size of the eye (the sum of the sizes of the pupil, the iris, and the sclera) may be calculated in order to acquire the degree of eye opening.

Here, at step S223, normalization may be performed in order to correct the difference in scale between the top, bottom, left and right positions of the pupil and the eye size data of the eye state information.

Min-Max normalization, Z-score normalization, or the like may be used for a normalization algorithm.

Also, in the method for biometric authentication based on an eye image according to an embodiment of the present disclosure, a registered eye image may be selected at step S230.

That is, a registered eye image may be selected at step S230 based on the similarity acquired by comparing the segmentation data and eye state information of the eye image to be authenticated with those of previously registered eye images.

Here, at step S230, the eye state information and segmentation data of the registered eye images may be acquired from the registered image storage unit 140.

Here, at step S230, a registered eye image most similar to the eye image to be authenticated may be selected using the eye state information and segmentation data of the eye image to be authenticated and those of the registered eye images.

Here, at step S230, the most similar registered eye image may be selected using the top, bottom, left and right positions of the pupil and the eye size.

Here, at step S230, the most similar registered eye image may be selected by calculating mean Intersection over Union (mIoU) between the segmentation data of the eye image to be authenticated and the segmentation data of the registered eye images.

Here, at step S230, respective weights for the difference in the top, bottom, left and right positions of the pupil between the eye image to be authenticated and the registered eye images, the difference in the eye size therebetween, and the mIoU therebetween are set, and an eye difference score (EyeDiffScore) may be calculated using Equation (1).

Here, at step S230, the registered eye image having the smallest eye difference score (EyeDiffScore) may be selected.

Here, at step S230, multiple registered eye images having an eye difference score equal to or less than a preset eye difference score (EyeDiffScore) may be alternatively selected.

Also, in the method for biometric authentication based on an eye image according to an embodiment of the present disclosure, feature vectors may be extracted at step S240.

That is, at step S240, feature vectors may be extracted from the eye image to be authenticated and the selected registered eye image.

Also, in the method for biometric authentication based on an eye image according to an embodiment of the present disclosure, the subject may be authenticated at step S250.

That is, at step S250, the subject may be authenticated based on the similarity.

Here, at step S250, the subject may be authenticated based on the result of comparing the feature vectors of the eye image to be authenticated with those of the selected registered eye image.

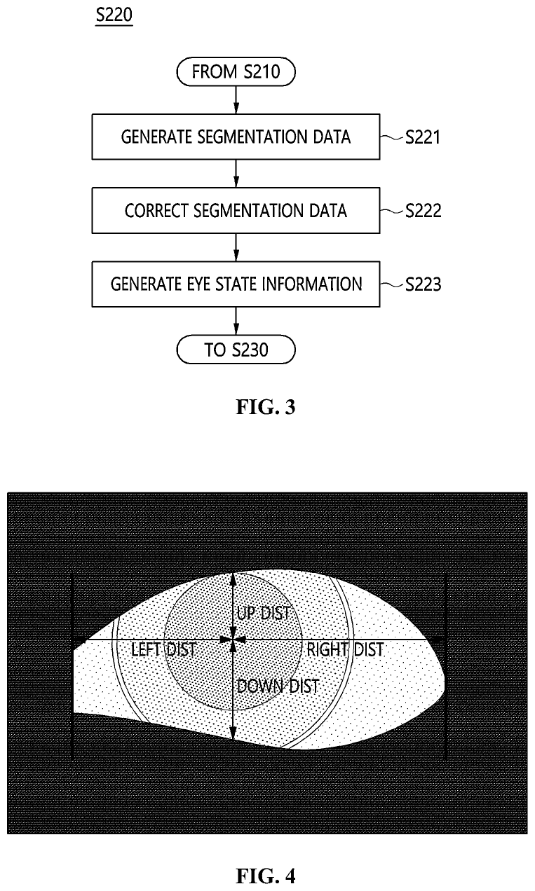

FIG. 4 is a view illustrating segmentation data of an eye image according to an embodiment of the present disclosure.

Referring to FIG. 4, it can be seen that ‘UP DIST’, ‘DOWN DIST’, ‘LEFT DIST’, and ‘RIGHT DIST’ indicate the distances from the center of the pupil to the top, bottom, left, and right positions in the segmentation data generated from an eye image.

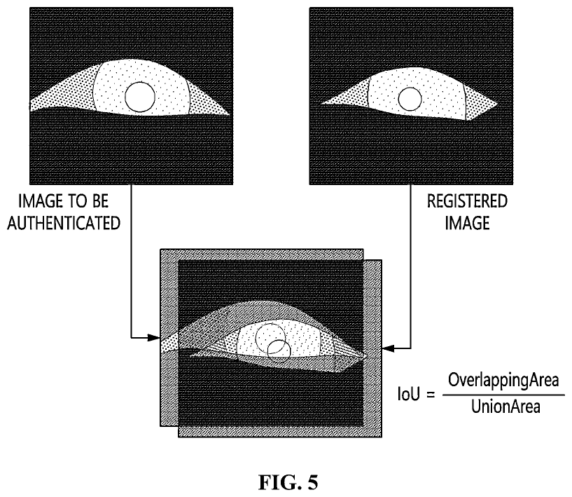

FIG. 5 is a view illustrating a process of calculating mIoU between the eye image to be authenticated and a registered eye image according to an embodiment of the present disclosure.

Referring to FIG. 5, it can be seen that mIoU is calculated from the segmentation data of the eye image to be authenticated and that of the registered eye image.

Here, mIoU is calculated by averaging the IoU calculation results of respective classes, which are calculated using the ratio of the overlapping area to the union area of the segmentation data.

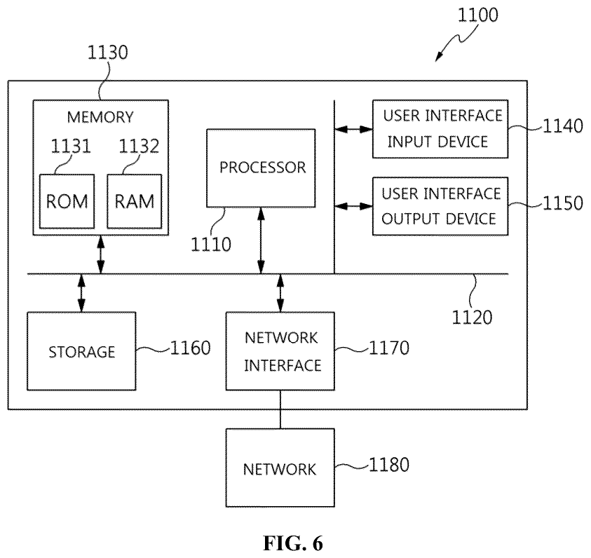

FIG. 6 is a view illustrating a computer system according to an embodiment of the present disclosure.

Referring to FIG. 6, the apparatus for biometric authentication based on an eye image according to an embodiment of the present disclosure may be implemented in a computer system 1100 including a computer-readable recording medium. As illustrated in FIG. 6, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for biometric authentication based on an eye image according to an embodiment of the present disclosure includes one or more processors 1110 and memory 1130 for storing at least one program executed by the one or more processors 1110. The at least one program receives an eye image to be authenticated that captures a region around an eye of a subject, generates segmentation data and eye state information from the eye image to be authenticated, selects a registered eye image based on similarity acquired by comparing the segmentation data and eye state information of the eye image to be authenticated with those of previously registered eye images, and authenticates the subject based on the similarity.

Here, the segmentation data may be configured such that the eye image capturing the region around the eye is divided into pupil, iris, sclera, and background regions.

Here, the at least one program may correct the tilt of the eye such that the left and right ends of the sclera are horizontally aligned in the segmentation data, and may correct the center of the image such that the center of the pupil becomes the center of the eye image.

Here, the at least one program may generate eye state information about the top, bottom, left, and right positions of the pupil and an eye size from the segmentation data.

Here, the at least one program may calculate an eye difference score from the sum of the difference in the top, bottom, left, and right positions of the pupil between the eye image to be authenticated and the registered eye image, the difference in the eye size therebetween, and mean Intersection over Union (mIoU) therebetween.

Here, the at least one program may calculate the eye difference score by setting respective weights for the difference in the top, bottom, left, and right positions of the pupil, the difference in the eye size, and the mIoU.

Here, the at least one program may extract feature vectors from the eye image to be authenticated and the selected registered eye image.

Here, the at least one program may authenticate the subject based on the result of comparing the feature vectors of the eye image to be authenticated with those of the selected registered eye image.

The present disclosure may perform biometric authentication by selecting an image most similar in shape to the eye image to be authenticated from among registered images.

Also, the present disclosure may improve authentication performance by selecting a registered eye image similar to the eye image to be authenticated.

As described above, the apparatus and method for biometric authentication based on an eye image according to the present disclosure are not limitedly applied to the configurations and operations of the above-described embodiments, but all or some of the embodiments may be selectively combined and configured, so the embodiments may be modified in various ways.

What is claimed is:

1. An apparatus for biometric authentication based on an eye image, comprising:
one or more processors; and
memory for storing at least one program executed by the one or more processors,
wherein the at least one program
receives an eye image to be authenticated that captures a region around an eye of a subject,
generates segmentation data and eye state information from the eye image to be authenticated,
selects a registered eye image based on similarity acquired by comparing the segmentation data and eye state information of the eye image to be authenticated with those of previously registered eye images, and
authenticates the subject based on the similarity.

2. The apparatus of claim 1, wherein the segmentation data is configured such that the eye image capturing the region around the eye is divided into regions of a pupil, an iris, a sclera, and a background.

3. The apparatus of claim 2, wherein the at least one program
corrects a tilt of the eye such that left and right ends of the sclera are horizontally aligned in the segmentation data, and
corrects a center of the image such that a center of the pupil becomes the center of the eye image.

4. The apparatus of claim 2, wherein the at least one program generates the eye state information about top, bottom, left, and right positions of the pupil and an eye size from the segmentation data.

5. The apparatus of claim 4, wherein the at least one program calculates an eye difference score using a sum of a difference in the top, bottom, left, and right positions of the pupil between the eye image to be authenticated and the registered eye image, a difference in the eye size therebetween, and mean Intersection over Union (mIoU) therebetween.

6. The apparatus of claim 5, wherein the at least one program calculates the eye difference score by setting respective weights for the difference in the top, bottom, left, and right positions of the pupil, the difference in the eye size, and the mIoU.

7. The apparatus of claim 1, wherein the at least one program extracts feature vectors from the eye image to be authenticated and the selected registered eye image.

8. The apparatus of claim 7, wherein the at least one program authenticates the subject based on a result of comparing the feature vectors of the eye image to be authenticated with those of the selected registered eye image.

9. A method for biometric authentication based on an eye image, performed by an apparatus for biometric authentication based on an eye image, comprising:
receiving an eye image to be authenticated that captures a region around an eye of a subject;
generating segmentation data and eye state information from the eye image to be authenticated;
selecting a registered eye image based on similarity acquired by comparing the segmentation data and eye state information of the eye image to be authenticated with those of previously registered eye images; and
authenticating the subject based on the similarity.

10. The method of claim 9, wherein the segmentation data is configured such that the eye image capturing the region around the eye is divided into regions of a pupil, an iris, a sclera, and a background.

11. The method of claim 10, wherein generating the segmentation data and the eye state information comprises
correcting a tilt of the eye such that left and right ends of the sclera are horizontally aligned in the segmentation data, and
correcting a center of the image such that a center of the pupil becomes the center of the eye image.

12. The method of claim 10, wherein generating the segmentation data and the eye state information comprises generating the eye state information about top, bottom, left, and right positions of the pupil and an eye size from the segmentation data.

13. The method of claim 12, wherein selecting the registered eye image comprises calculating an eye difference score using a sum of a difference in the top, bottom, left, and right positions of the pupil between the eye image to be authenticated and the registered eye image, a difference in the eye size therebetween, and mean Intersection over Union (mIoU) therebetween.

14. The method of claim 13, wherein selecting the registered eye image comprises calculating the eye difference score by setting respective weights for the difference in the top, bottom, left, and right positions of the pupil, the difference in the eye size, and the mIoU.

15. The method of claim 9, further comprising:
extracting feature vectors from the eye image to be authenticated and the selected registered eye image.

16. The method of claim 15, wherein authenticating the subject comprises authenticating the subject based on a result of comparing the feature vectors of the eye image to be authenticated with those of the selected registered eye image.
